(19) United States
(12) Patent Application Publication
(10) Pub. No.: US 2024/0357014 A1
(43) Pub. Date: Oct. 24, 2024

(54) METHOD, REMOTE ACCESS SERVER, COMMUNICATION DEVICE AND SYSTEM FOR REMOTE ACCESS TO A VEHICLE

(71) Applicant: HELLA GUTMANN SOLUTIONS GMBH, Ihringen (DE)

(72) Inventors: Ralph Kolberg, Freiburg i. Br. (DE); Felix GRUN, Ihringen (DE); Heiko ABRAHAM, Ihringen (DE); Matthias FRÖDRICH, Ihringen (DE); Sven GEISSERT, Ihringen (DE); Oliver DAHMEN, Ihringen (DE)

(21) Appl. No.: 18/684,782

(22) PCT Filed: Aug. 4, 2022
(86) PCT No.: PCT/EP2022/071933

§ 371 Date: Feb. 19, 2024

(30) Foreign Application Priority Data
Aug. 27, 2021 (EP) 21193495.5

(51) Int. Cl. H04L 67/125; G07C 5/00; H04L 67/00; H04W 4/44

(52) U.S. Cl. CPC H04L 67/125; G07C 5/008; H04L 67/34; H04W 4/44

(57) ABSTRACT

The present invention relates to various methods, devices (20, 30, 40) and systems (100) for remotely accessing a vehicle (10).

The present invention relates to methods, devices and systems for remote access to a vehicle.

Modern vehicles are complex electrical and mechanical systems which use many components that communicate with one another in order to support reliable and efficient vehicle operation. Such components can be susceptible to faults, failures and errors that can affect the operation of a vehicle. If such faults, failures or errors occur, the affected component can trigger a corresponding error code, for example a Diagnostic Trouble Code (DTC). The fault code is usually generated by a vehicle control device and stored in a memory on the vehicle. Depending on the severity of the fault, a warning signal or an error message can be issued, for example, prompting the driver to visit a repair shop.

By evaluating the error code, a statement can be made as to which vehicle components are faulty or defective and require repair, for example. For this so-called vehicle diagnosis, a vehicle diagnostics interface is usually provided in the vehicle, which is often located in the driver's footwell.

Typically, an external vehicle diagnostic tool is connected to the vehicle diagnostic interface in order to read out the stored fault codes. The error codes are then analyzed by the vehicle diagnostic device in order to diagnose which components need to be repaired or replaced to correct the problem. Such vehicle diagnostic devices have proven their worth in everyday repair shop use.

There are also situations in which a vehicle diagnostics device is not available or in which there is a lack of trained personnel to evaluate or operate the vehicle diagnostics device. If, for example, a vehicle breaks down, it is often not possible to carry out vehicle diagnosis or even comprehensive vehicle-specific diagnosis on site. Even for test drives in inaccessible areas, on-site vehicle diagnostics are not always possible. During the test drive, for example, an unusual behavior occurs that only occurs in a very special driving situation.

A detailed examination by an expert or developer would be desirable, but they are rarely in the vicinity.

Even with known error codes, it is often difficult to determine the actual cause of the error message. If, for example, an increased coolant temperature is reported as an error, the causes of the error can be varied, such as a lack of coolant due to a leak in the cooling system, a lack of fluid flow due to vapor bubbles or a defective coolant pump, or overheating due to previous vehicle stress and climatic conditions. For this reason, the vehicle is often first taken to the repair shop for a vehicle diagnosis, although the cause of the fault could sometimes even be rectified on site. It can also happen that on arrival at the repair shop, it is discovered that the appropriate spare parts, the necessary tools or appropriately trained specialists are not available to rectify the cause of the fault. In this case, it would have been better to go to another repair shop that would have been able to rectify the fault.

In some vehicles, certain error codes, operating parameters and vehicle information can be read out, which are then sent to a remote telematics server for evaluation. However, comprehensive remote access to on-board control devices or comprehensive vehicle diagnosis is usually not possible, as access rights are denied and the telematics server is usually not able to carry out comprehensive and vehicle-specific vehicle diagnosis.

Due to the increasing complexity of vehicle technology, there is therefore a great need for fast and reliable fault determination, especially on site in the event of a breakdown and outside the repair shop. In particular, it would be desirable to find a practical solution for determining the causes of faults.

US 2017/0013559 A1 describes a telematics system that is connected to a vehicle.

According to the invention described, the problems mentioned are solved at least in part or to a substantial extent by the methods and apparatus of the independent claims. Advantageous features and developments result from the features of the dependent claims and from the following description.

According to a first aspect, a method for remote access to a vehicle by means of a remote access server is proposed. The remote access server is designed to access at least one on-board control device in order to carry out the remote access.

Furthermore, a communication device arranged in, on or by the vehicle is designed to communicate with a intermediate server via an air interface and to communicate with at least one on-board control device via a further communication interface. The air interface referred to in this document can in particular be part of a mobile radio network, whereby the mobile radio network is configured, for example, according to one of the standards G1, G2, G3, G4, G5 or higher.

The communication device has
a data transmission mode which enables data transmission from the at least one on-board control device to the intermediate server, and
a remote access mode, which enables remote access by the remote access server to the at least one on-board control device via the intermediate server.

The method comprises at least the steps of:
sending an activation message from the remote access server via the intermediate server to the communication device to activate the remote access mode and switch from the data transmission mode to the remote access mode, and
carrying out remote access to the at least one on-board control device by the remote access server.

The proposed method therefore enables remote access to the at least one on-board control device by means of the remote access server. The method is preferably carried out solely or at least by the remote access server. The remote access mode is enabled by means of the activation message. This ensures that only an authorized instance, namely the remote access server, can access the respective vehicle control device. In this respect, remote access in data transmission mode is not possible.

On the other hand, the intermediate server is connected between the vehicle and the remote access server and mediates the communication between the vehicle and the remote access server. This allows remote access even if a direct connection between the vehicle and the remote access server is not possible. This also means that existing solutions can be used or systems that are already operational can be expanded on a modular basis.

Optionally, the method comprises the step:
periodic sending of keep-alive signals to the communication device to maintain the remote access mode.

It may be that the keep-alive signals are sent depending on a determined latency time.

According to a second aspect of the present invention, a further method for remotely accessing a vehicle is proposed. A communication device arranged in, on or by the vehicle is designed to communicate with a intermediate server via an air interface and to communicate with at least one on-board control device via a further communication interface.

The communication device has:
a data transmission mode which enables data transmission from the at least one on-board control device to the intermediate server, and
a remote access mode which enables access by a remote access server to the at least one on-board control device via the intermediate server.

The method comprises the steps of:
receiving an activation message from the remote access server via the intermediate server and
switching from data transmission mode to remote access mode based on the activation message.

The method is preferably carried out solely or at least by the communication device.

Optionally, the method may comprise the following step:
receiving a consent message, in particular a text or voice message, to consent to remote access, and
switching from the data transmission mode to the remote access mode based on the activation message and the consent message.

The consent message can be entered directly on the communication device, for example. In this case, the communication device can have a corresponding input device. However, the consent message can also be received by a mobile device which is communicatively connected to the communication device, e.g. wirelessly and/or by wire. The consent message can be used to ensure that remote access is only permitted if it has been confirmed and approved by the user. This can prevent unauthorized access such as hacker attacks.

The method may further comprise the following steps: receiving a keep-alive signal, which is preferably received at periodic intervals, and maintaining the remote access mode depending on the keep-alive signal.

According to a third aspect, a further method for remote access to a vehicle is proposed.

The method comprises the steps of:
receiving an activation message from a remote access server and
forwarding the activation message to a communication device via an air interface to switch the communication device from a data transmission mode to a remote access mode, which enables access by the remote access server to at least one on-board control device via the intermediate server, based on the activation message.

The process is preferably carried out solely or at least by the intermediate server.

The methods according to the first aspect, the second aspect and the third aspect complement each other and are in particular compatible with each other. In this respect, the features and processes of the methods according to the first aspect, the second aspect and the third aspect can be combined with one another. In the following, for the sake of simplicity, reference is sometimes made to “the method” or “at least one of the methods”. It is clear to the person skilled in the art that only one of the methods, at least one, at least two or all three of the methods may be meant.

Optionally, in at least one of the above methods, the following step may be provided:
establishing a first communication link between the communication device and the intermediate server via the air interface.

The first communication link is often established first. The first communication link takes place in data transmission mode by default. In data transmission mode, data can be exchanged between the communication device and the intermediate server.

Optionally, in at least one of the above methods, the following step may be provided:
Establishing a second communication link between the intermediate server and the remote access server.

The establishment of the first communication link can automatically trigger the establishment of the second communication link. Alternatively, it is also possible for the second communication link to be triggered by another event, for example the receipt of a message from a mobile device. Alternatively, the second communication link can already exist before the first communication link is established. Sometimes the second communication link can be a permanent communication link.

Subsequently, the following step may be provided in at least one of the above methods:
establishing a bidirectional communication channel between the communication device and the remote access server via the intermediate server.

The bidirectional communication channel can be designed as a so-called tunnel, which can be encrypted. Preferably, remote access is only permitted once the bidirectional communication channel or tunnel has been established. In this way, insecure network protocols embedded in a secure and encrypted network protocol can be transported in a tap-proof and tamper-proof manner.

Optionally, the following steps may be provided in at least one of the above methods:
receiving a request for remote access, the request containing at least one identification means for identifying the vehicle and/or for identifying the communication device,
establishing the communication channel between the communication device and the remote access server based on the request,
carrying out remote access by the remote access server via the communication channel.

Remote access can therefore be initiated with the aforementioned request. The request can be received at various points, for example in the communication device, in the intermediate server and/or in the remote access server. The request for remote access can optionally be generated in a mobile device and/or forwarded by the mobile device. For this purpose, the mobile device can communicate with the communication device, the intermediate server and/or the remote access server.

Further security measures can be provided to prevent unwanted access to the on-board control device. For example, the following steps can be implemented in at least one of the above-mentioned methods:
judging whether the vehicle is moving, in particular using GPS data, satellite data, radio location signals or movement data from motion sensors,
if it is determined that the vehicle is moving: terminating the remote access mode and/or activating the data transmission mode and/or canceling the communication channel between the communication device and the remote access server,
if it is determined that the vehicle is at a standstill: activating the remote access mode and/or establishing the communication channel and/or maintaining the communication channel.

The assessment of whether the vehicle is moving or not can be carried out by the communication device, the intermediate server and/or the remote access server. This can depend, for example, on which movement data is used. If the movement data from on-board movement sensors is used, the assessment can be advantageously carried out by the communication device. If GPS data, satellite data, radio positioning signals are used for the assessment, the assessment can be carried out by the intermediate server or the remote access server.

In the above-mentioned data transmission mode, simple communication between the communication device and the intermediate server is possible, in particular unidirectional communication from the control devices to the intermediate server via the communication device. During data transmission in data transmission mode, telematics data can be transmitted, the telematics data comprising vehicle identification data, fault codes and/or vehicle sensor readings, in particular according to a standardized or specific protocol. In the data transmission mode, data, functions, programs or settings stored in the on-board control devices can often only be read out, but not created or changed.

In some embodiments, the vehicle has a plurality of control devices, for example at least 5, at least 10 or at least 20 control devices. It may be that the data transmission from the on-board control devices to the intermediate server in data transmission mode is restricted to a predetermined first group of on-board control devices. In the following, the first group of control devices mentioned is also referred to as the first control devices. This means that not all control devices can communicate with external devices (communication device, intermediate server and/or remote access server) in the data transmission mode.

The first control devices can, for example, be assigned to vehicle functions that are non-critical or non-relevant for the safety of the vehicle, or relate exclusively to emissions-related data/functions, such as engine control, air conditioning or emissions control functions. The first control devices may comprise one or, in rarer cases, several control devices, for example a first number of control devices. In some embodiments, only a (SAE or ISO) standardized protocol method and standardized protocol parameters are used for this/these control device(s).

In the remote access mode, remote access can extend to a second group of on-board control devices. The first group typically differs from the first group. The control devices of the second group can be predetermined, but do not have to be. The second control devices may be relevant in the event of a breakdown or have vehicle safety-relevant functions such as braking, steering, engine control, etc. In addition, the first group of control devices can be at least partially or completely contained in the second group. The second control devices can comprise a second number of control devices. The second number is usually different from the first number and is usually larger, preferably considerably larger than the first number, e.g. at least two times larger or at least five times larger. There may be a partial overlap between the first and second control devices in remote access mode. However, the first group and the second group can also be completely different from each other, i.e. they do not have a common control device. The second group is typically not restricted; optionally, remote access in the remote access mode can extend to all on-board control devices. The scope of the diagnostic parameters is usually more extensive and detailed in the second group.

The functionalities and access rights to at least one vehicle control device are often restricted in the data transmission mode compared to the remote access mode. In the remote access mode, the remote access server can be authorized to read, write and/or change data, settings and/or programs in the on-board control device. On the other hand, data, programs and/or settings of the control device can only be read in the data transmission mode. In the data transmission mode, data, settings and/or programs typically cannot be changed, written and/or overwritten by external devices—i.e. outside the vehicle control device or outside the vehicle—such as the communication device, the remote access server and/or the intermediate server due to a lack of authorization. Optionally, remote access includes remote operation, remote control, remote diagnostics, remote support, remote configuration, remote maintenance, software updating and/or remote flashing of the on-board control device by the remote access server. Preferably, remote access is based on a vehicle identification feature and/or a control device identification feature. Thus, the remote access and/or the activation message can be configured based on a vehicle identification feature and/or a control device identification feature.

In particular, the activation message can be generated in relation to the vehicle identification feature and/or the control device identification feature. This can be advantageous, as different vehicle manufacturers usually use different communication protocols for communication with the control devices in the vehicle.

The method can contain at least one of the following steps:
receiving at least one vehicle identification feature, wherein the vehicle identification feature comprises a vehicle identification number and/or an engine code and/or an ECU identification number,
comparing the vehicle identification feature with known vehicle identification features in a database and
recognition of the vehicle using the comparison, preferably across vehicle manufacturers and independent of the vehicle manufacturer.

The vehicle identification feature specifies, for example, the vehicle manufacturer and/or a vehicle type of the vehicle and, if applicable, equipment features of the vehicle such as the engine variant or injection system. The vehicle identification feature can, for example, comprise a vehicle-specific number, such as a vehicle identification number (VIN), which can be used to uniquely identify a vehicle. With the help of the vehicle identification feature, information on the vehicle or on comparable vehicles from the database can be easily determined. It has been found that the VIN is not always sufficient to uniquely establish the identity of the vehicle. In this case, at least one further vehicle identification feature can be used, for example an engine code and/or an ECU identification number and/or a short designation of the vehicle. The code designation of the vehicle can be stored in a controller of the vehicle and can provide information regarding the manufacturer, type, and/or equipment of the vehicle.

By combining at least two vehicle identification features, the identity of the vehicle can be deduced and the vehicle (manufacturer, type and/or equipment) can be recognized. Alternatively, the identity of the vehicle can be determined by recognizing a pattern in the vehicle identification feature and comparing it with identical or similar patterns in the database.

The required communication parameters can thus be selected and compiled on a case-specific basis.

Furthermore, according to a fourth aspect, a remote access server is provided, which is configured to carry out the method according to the first aspect.

Furthermore, according to a fifth aspect, a communication device is provided, which is configured to carry out the above-mentioned method according to the second aspect.

The communication device has the following features:
a data transmission mode which enables data transmission from the at least one on-board control device to the intermediate server, and
a remote access mode which enables access by a remote access server to the at least one on-board control device via the intermediate server.

The communication device can have a switch, in particular a virtual switch, which is designed to switch between the data transmission mode and the remote access mode, in particular taking into account the activation message. The switch can be controlled and/or enabled by the server, e.g. based on the activation message from the server or an additional, separate message. Alternatively or additionally, the switching of modes can be enabled and/or confirmed via the switch by a person in the vehicle, for example via the above-mentioned consent message. The switch can therefore be provided as an additional safety measure to confirm and/or initiate the switching of modes by a person in the vehicle. It is possible that the switching of modes can only be carried out once both the server and the person in the vehicle have given their approval. In this case, the switch is only activated when both approvals are available. This can prevent unauthorized persons from accessing the vehicle control devices via the server, e.g. hacker attacks.

The communication device can be designed to communicate with the at least one vehicle diagnostic device via a diagnostic interface provided in the vehicle. The communication interface of the communication device is connectable to a diagnostic interface on the vehicle, in particular mechanically and/or electrically. For this purpose, the communication device can have a plug that can be mechanically and electrically connected to the diagnostic interface. Sometimes the communication device can be designed as a dongle. The communication device can sometimes also communicate wirelessly with the on-board vehicle control device, the diagnostic interface or the vehicle, preferably via a near-field connection such as Bluetooth, WLAN or similar.

The communication device can therefore communicate wired or wirelessly with the vehicle's control device via the near-field connection on the one hand and communicate wirelessly with the intermediate server via the air interface, in particular the mobile network, on the other. The communication device thus creates the conditions for a good radio quality or wireless communication link with the intermediate server located outside the vehicle.

It should be noted that the communication device and the at least one vehicle diagnostic device can be separate but connectable objects. Alternatively, however, the communication device can also be an integral part of the vehicle and as such be integrated into it.

According to a sixth aspect, an intermediate server is proposed, which is configured to carry out the method according to the third aspect. In particular, the intermediate server is designed to communicate via an air interface with a communication device arranged in, on or by the vehicle. The intermediate server is also designed to communicate with a remote access server. The intermediate server can already communicate with the communication device in the data transmission mode.

The communication device, the remote access server and the intermediate server complement each other and, in particular, are compatible each other. Therefore, the features of the devices according to the fourth and fifth and/or sixth aspect can be combined with each other, in particular to form a system.

According to a seventh aspect, a system is provided. The system comprises at least the above-mentioned remote access server and the above-mentioned communication device. Optionally, the system can also comprise the aforementioned intermediate server. The system can possibly be manufactured and marketed without the intermediate server, whereby the scope of protection of the claimed system in these cases also extends to such systems which do not contain the intermediate server.

It should be emphasized at this point that features mentioned only in relation to the methods can also be claimed for the said devices or the said system and vice versa. It goes without saying that the above-described embodiments can be combined with one another provided that the combinations do not exclude one another.

In the following, embodiments of the invention are explained in greater detail with reference to the accompanying drawings. The figures are schematized and partially simplified. In the drawings:

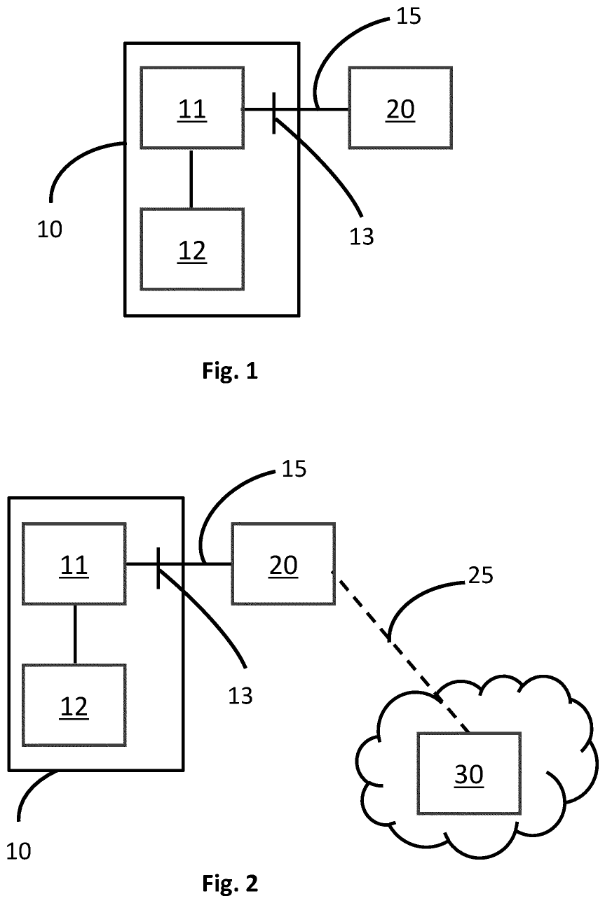

FIG. 1 is a schematic representation of a communication device connected to a vehicle;

FIG. 2 is a schematic representation of a communication device connected to a vehicle, which is connected to a intermediate server via an air interface;

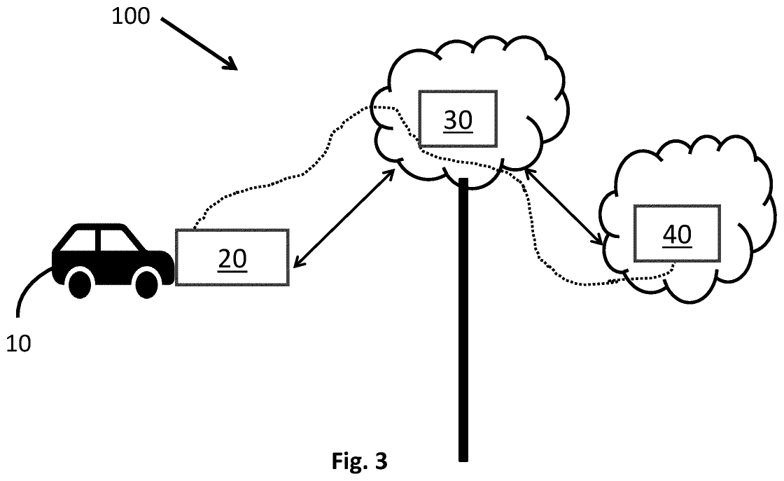

FIG. 3 is a schematic representation of a system for carrying out remote access to on-board control devices;

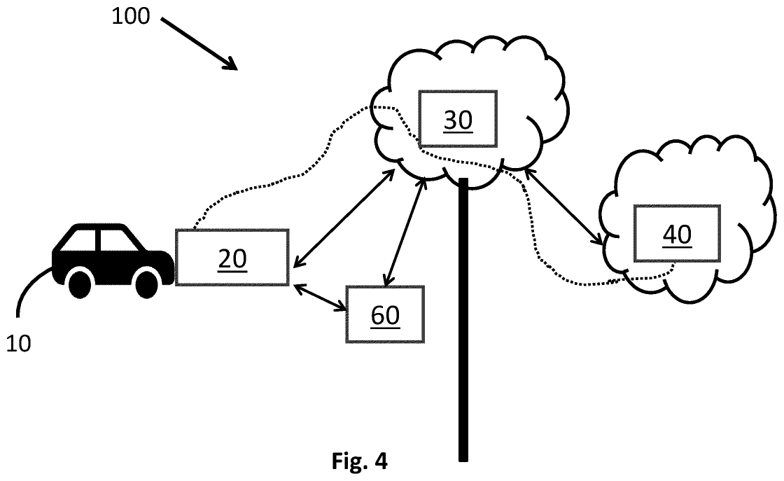

FIG. 4 is a schematic representation of a system for carrying out remote access to on-board control devices;

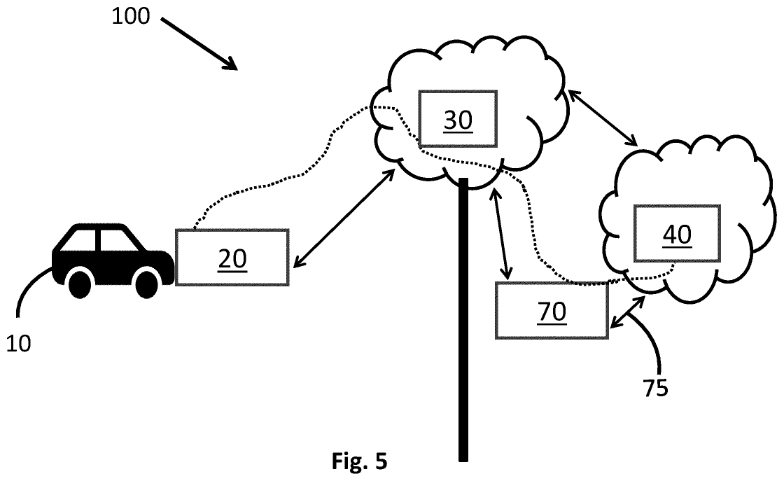

FIG. 5 is a schematic representation of a system for carrying out remote access to on-board control devices;

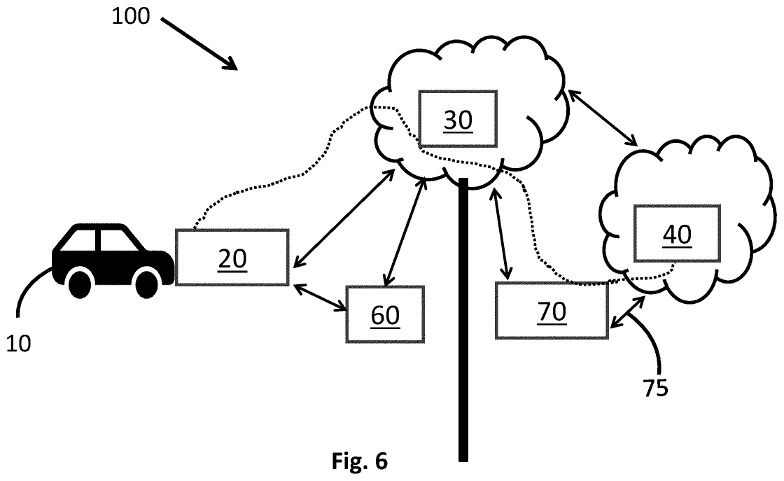

FIG. 6 is a schematic representation of a system for carrying out remote access to on-board control devices;

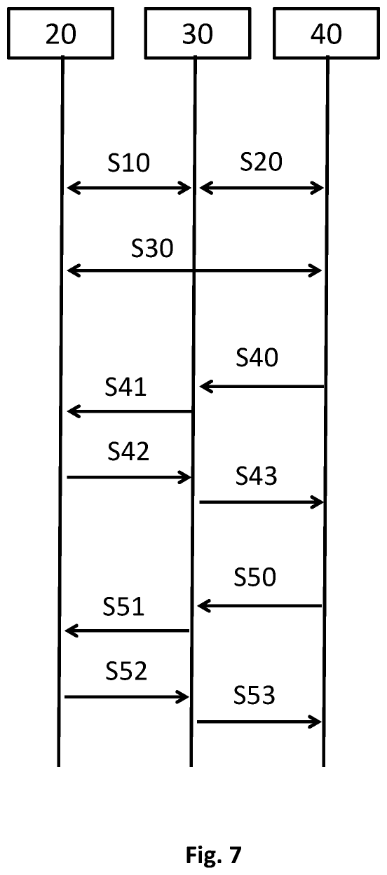

FIG. 7 is a schematic representation of a communication sequence between a communication device, a intermediate server and a remote access server.

In the drawings, recurrent features are provided with the same reference signs.

FIGS. 1-6 show a schematic representation of a vehicle 10. Although a car is shown in FIGS. 2-6, the vehicle 10 may also be a motorcycle, a truck or the like. The vehicle 10 has a plurality of control devices 11, 12, e.g. at least 10 or more. The increasing networking of control devices 11, 12 in today's motor vehicles offers ever better possibilities for influencing functionalities in the vehicle 10, e.g. better diagnostic possibilities in the event of a fault or possibilities for remote control of functions and/or components of the vehicle 10. The control devices 11, 12 are usually connected to each other, e.g. via a CAN bus system. The control device 11 in FIG. 1 can be representative of a first group of control devices 11. The second control device 12 in FIG. 1 can be representative of a second group of control devices 12.

The control devices 11, 12 are usually each connected to a large number of sensors which record measured values or operating parameters during operation of the vehicle 10. Conceivable sensor measurement variables include, for example, a coolant temperature, an engine temperature, a vehicle speed, an engine speed, an engine torque, an ambient temperature, an ambient air pressure, a boost pressure of an exhaust turbocharger of the drive engine, an engaged gear of a gearbox of the vehicle 10, etc. If a measured value measured by a sensor falls below or exceeds a certain target value range, depending on the sensor, the corresponding control device 11, 12 generates an error code, which is usually stored in a memory of the respective control device 11, 12. The fault code is assigned to a fault state and for example contains a code number for identifying fault functions that can occur during operation of a vehicle. The fault code is also referred to as a diagnostic fault code or a diagnostic trouble code (DTC). In addition, the control devices 11, 12 can be connected directly or at least indirectly, e.g. via the CAN bus system, to a vehicle diagnostics interface 13. Instead of referring to individual components 11, 12, 13 of the vehicle 10, reference is sometimes only made to the vehicle 10 for the sake of simplicity.

FIG. 1 also shows a communication device 20, which typically comprises a control and processing unit, a memory and communication means. Typically, the communication device 20 can be connected to the vehicle diagnostic interface 13 of the vehicle 10 by means of signal lines 15 (i.e. wired) and thus be connected to the CAN bus system and the control devices 11, 12. In some embodiments, the communication device 20 can be designed as a dongle.

The communication device 20 typically has a connector that is compatible with the vehicle diagnostic interface 13 and can be plugged into it. When connecting the plug to the vehicle diagnostic interface 13, both are connected to one another electrically and mechanically. The connector can be provided directly on a housing of the communication device 20. Alternatively, the plug can also be connected to other components of the communication device 20 using an extension cable. In some cases, a wireless communication link of the communication device 20 with the vehicle 10 and the control devices 11, 12 is possible as an alternative or in addition, for example a wireless local connection such as Bluetooth or WiFi. Sometimes the communication device 20 is also an integral part of the vehicle 10 and as such is integrated into it. A corresponding communication interface can then be provided in the vehicle for communication with the control units 11, 12, for example via the CAN bus system. The communication device 20 can therefore be arranged in, on or by the vehicle 10. The communication device 20 is designed in particular to process outgoing data streams from the control units 11, 12 and to process data streams from external units 30, 40, 60, 70 going to the vehicle. In this respect, the communication device 20 can have a first transmitter and receiver unit and a second transmitter and receiver unit, which are provided on the one hand for communication or data stream towards the vehicle 10 and on the other hand for communication or data stream out of the vehicle 10.

The communication device 20 is also designed to communicate with other external components via an air interface 25, which in particular includes a mobile radio network in accordance with one of the mobile radio standards G1-G5 or higher. In some embodiments, the communication device 20 is designed as a gateway device, which can be assigned to receiving and transmitting data via the air interface 25 and, for example, for ensuring security functions. The communication device 20 can be uniquely identified by an identification feature, e.g. IMEI (international mobile equipment identity).

The invention provides methods for carrying out remote access to a vehicle 10, in particular the control devices 11, 12 of the vehicle 10. The methods are preferably carried out by means of a system 100 indicated in FIGS. 3-6, which comprises the aforementioned communication device 20, a intermediate server 30 and a remote access server 40. The communication device 20 described in connection with FIG. 1 is designed in particular to communicate with the intermediate server 30 via the aforementioned air interface 25, see FIG. 2 and FIGS. 3-6, and to communicate with the remote access server 40 via the intermediate server 30.

The communication device 20 is in data transmission mode by default, i.e. if no other command is present or setting has been made. The data transmission mode of the communication device 20 enables data transmission between the communication device 20 and the intermediate server 30 as well as data transmission from the on-board control devices 11, 12 or the first group of control devices 11 and the second group of control devices 12 to the intermediate server 30 via the communication device 20.

During data transmission in data transmission mode, telematics data can be transmitted from the control devices 11, 12 to the intermediate server 30, whereby the telematics data can comprise vehicle identification data, fault codes and/or vehicle sensor measured values, in particular according to a standardized or specific protocol. Usually, only data or settings from the control devices 11, 12 and the associated sensors can be read out and sent to the intermediate server 30 in data transmission mode. However, the data or settings stored in the vehicle control devices 11, 12 cannot usually be changed in data transmission mode. By transmitting the telematics data of the vehicle control devices 11, 12 to the intermediate server 30 via the communication device 20, limited vehicle diagnostic functions can be carried out in the intermediate server 30, which only relate to reading out and evaluating the telematics data.

Optionally, in the data transmission mode, the data transmission from the vehicle 10 to the intermediate server 30 can be limited to the aforementioned first group of on-board control devices 11. It can thus be the case in the data transmission mode that not all control devices 11, 12 communicate with external devices such as the intermediate server 30 or the remote access server 40 or transmit data to these external devices. The first control devices 11 can, for example, be assigned to vehicle functions that are not critical in diagnostic communication or for vehicle safety. Exemplary functions refer to the operation of the drive train or air conditioning system, or similar.

In the data transmission mode, only unidirectional communication from the control devices 11, 12 to the intermediate server 30 via the communication device 20 is possible.

The intermediate server 30 is either not authorized or not able or both to carry out remote access to the first control devices 11 and/or the second control devices 12. A remote access server 40 is provided to enable such remote access. The communication device 20 has a remote access mode for this purpose, which is required to enable remote access by the remote access server 40 to the on-board control devices 11, 12 via the intermediate server 30.

In remote access mode, the remote access server 40 can be authorized to read, write and change data, settings and/or programs in the on-board control device 11, 12. Reading here means that the data is sent from the control devices 11, 12 to the remote access server 40 via the communication device 20 and the intermediate server 30. Writing and changing here means that a message with the corresponding write or change command is sent from the remote access server 40 to the respective control device 11, 12, and a write or change process is initiated in the respective control device 11, 12.

The remote access includes, for example, remote operation, remote query, remote control, remote diagnosis, remote support, remote configuration, remote maintenance, software download, software update and/or remote flashing of the on-board control device 11, 12 by the remote access server 40. The remote access server 40 can have a dedicated server or a dedicated processor unit for each of these functionalities. Some functionalities can also be carried out in combination by a server or a processor unit.

Remote operation or remote query is essentially understood to mean the remote control of vehicle functions, in particular comfort functions such as switching on the auxiliary heating, etc., as well as querying the vehicle status and/or operating parameters.

Remote diagnostics involves remotely reading diagnostic data from the vehicle, analyzing it and, if necessary, generating a recommendation for further action. The data is analyzed and the recommendation is generated by the remote access server 40. In contrast to the data transmission mode, the remote access mode allows unrestricted vehicle diagnostics functions to be carried out. For example, error codes can be deleted, peripheral components (actuators) can be controlled and, in particular, operating values/learning values can be reset, whereas this is not possible in the data transmission mode.

Remote support represents the solving of a problem in the vehicle 10 or assistance in solving the problem by the remote access server 40. This can be done, for example, by sending recommendations for action to the vehicle 10 or the driver.

Remote configuration refers in particular to setting settings, especially changes to settings, or updating settings in the control devices 11, 12 via the remote access server 40.

Remote maintenance essentially represents the monitoring of the vehicle condition and access to the maintenance data in the vehicle 10 or the control devices 11, 12 from a central location, namely the remote access server 40, in order to check whether, when and which measures are carried out to maintain a target condition of the vehicle.

In this context, another function to be mentioned is the so-called software download, software update or remote flashing, with the help of which a new program code, an updated program code or parameters are applied to the software configurable systems in the vehicle 10, for example the control devices 11, 12, in order to increase the functionality or performance. The control devices 11, 12 can be reprogrammed during remote flashing, for example. These functions typically cannot be realized in the data transmission mode.

In addition, basic settings for sensors of driving assistance systems (e.g. camera, radar, etc.) that require a driving cycle can be triggered.

Learning values that are stored in the control devices and may cause malfunctions can be deleted in remote access mode (similar process to a reset in IT technology).

In the remote access mode, remote access can extend to a second group of predetermined on-board control devices 12. The second control devices 12 can have vehicle safety-relevant functions such as braking, steering, engine control, etc. The remote access mode can also be used to access control devices 12 that are relevant in the event of a breakdown. In this respect, the second control devices 12 can be limited to those control devices 12 which can cause the vehicle 10 to break down. In principle, however, the control device functions of all control devices in the vehicle can be fully accessed. For the purposes of this document, a breakdown is a sudden occurrence of damage or a technical fault that makes it at least temporarily impossible or very difficult or risky to continue driving the vehicle 10. Such control devices are familiar to the person skilled in the art because in the event of a breakdown they are usually very specific control devices.

The second control devices 12 can comprise a second number of control devices. The second number can be greater than the first number. There may be a partial overlap of the first and second control devices 11, 12 in the remote access mode. The second group of control devices 12 can include the first group of control devices 11. Optionally, remote access in the remote access mode can extend to all control devices 11, 12.

Furthermore, it may be the case that the communication device 20 in the remote access mode only forwards messages, requests or commands coming from the remote access server 40 to the respective control device 11, 12. By means of appropriate encryptions or codes, the communication device 20 may be able to recognize whether the messages, requests or commands originate from the remote access server 40 or whether they have another origin, such as the intermediate server 30.

The data transmission mode and the remote access mode can therefore differ from each other in at least one of the following points:
limited vehicle diagnostics in the data transmission mode,
full vehicle diagnostics in the remote access mode,
different groups of control devices 11, 12 are addressed,
reading, writing and changing data, settings and/or programs stored in the control devices 11, 12 in the remote access mode,
in the data transmission mode, only reading data and/or settings stored in the control devices 11, and/or
in the remote access mode: forwarding messages, requests or commands to the control devices 11, 12, which typically originate exclusively from the remote access server 40.

In order to switch between the data transmission mode and the remote access mode, the communication device 20 can have a switch, in particular a logical or virtual switch. Flipping the switch allows for switching between the two modes. The switch can be provided as an additional safety measure to confirm and/or initiate the switching of modes by a person in the vehicle. Activation of the remote access mode, activation of the switch or switching between the two modes is initiated by an activation message, which is sent from the remote access server 40 to the communication device 20 via the intermediate server 30. This process is described below.

First, a first communication link is established between the communication device 20 and the intermediate server 30 via the air interface 25 (S10).

Afterwards—or before or at the same time—a second communication link is established between the intermediate server 30 and the remote access server 40 (S20). The establishment of the first communication link can automatically trigger the establishment of the second communication link. Alternatively, the second communication link can also be triggered by another event, for example the receipt of a message from a mobile device 60, see below. Alternatively, the second communication link can already exist before the first communication link is established. For example, the second communication link may be a permanent communication link between the intermediate server 30 and the remote access server 40, which continues beyond the remote access to the respective vehicle 10, while the first communication link is limited in time to the remote access.

A bidirectional communication channel is then established between the communication device 20 and the remote access server (S30), which can also be referred to as a tunnel. The tunnel is preferably set up using a secure and encrypted network protocol so that the tunnel is tap-proof and tamper-proof. This aspect can be particularly important for safety-relevant or safety-critical control devices 12, which must not be accessed by unauthorized persons or entities.

Now the intermediate server 30 is able to mediate a communication between the remote access server 40 and the communication device 20. Thus, the intermediate server 30 can forward data or messages from the remote access server 40 to the communication device 20 and vice versa by means of the bidirectional communication channel.

The remote access server 40 then performs the following step:
sending (S40) an activation message from the remote access server 40 via the intermediate server 30 to the communication device 20 to activate the remote access mode and switch from the data transmission mode to the remote access mode.

After receiving the activation message from the remote access server 40, the intermediate server 30 sends (S41) the activation message to the communication device 20. In some embodiments, the activation message is simply forwarded by the intermediate server 30. In other embodiments, the activation message is encoded, encrypted, modified or translated by the intermediate server according to a protocol as required, for example to enable the communication device 20 to read, decode, decrypt and/or support the activation message.

The communication device 20 then switches from the data transmission mode to the remote access mode based on the activation message. After this, a confirmation of the mode change and/or a confirmation of receipt of the activation message can be sent from the communication device 20 to the intermediate server 30, and optionally further to the remote access server 40 (S42, S43).

Preferably, remote access is based on a vehicle identification feature and/or a control device identification feature. In this case, it may be advantageous to carry out the following steps:
receiving at least one vehicle identification feature, wherein the vehicle identification feature comprises a vehicle identification number and/or an engine code and/or an ECU identification number.

The vehicle identification feature can, for example, be sent to the intermediate server 30 by a customer via a mobile device 60 (see FIGS. 4 and 6). Alternatively or additionally, the communication device 20 can also send the vehicle identification feature to the intermediate server 30.

The intermediate server 30 forwards the vehicle identification feature to the remote access server 40 and requests the necessary configuration for the vehicle identification feature. The next steps preferably take place in the remote access server 40, but can alternatively also take place in the intermediate server 30:
comparing the vehicle identification feature with known vehicle identification features in a database and
recognizing the vehicle 10 by comparison, preferably across vehicle manufacturers and independent of the vehicle manufacturer.

The vehicle identification feature can thus be received and processed in the intermediate server 30 and/or in the remote access server 40. The said database can thus be a component of the intermediate server 30 and/or the remote access server 40. Based on the vehicle identification feature 10, a specific configuration can be generated for remote access and/or for communication between the units 10, 20, 30, 40 of the system. This is because the transmission and reception protocols for the control devices 11, 12 installed in the vehicle 10 often differ depending on the vehicle manufacturer and/or control device manufacturer. With the solution presented here, the data packets or messages sent in the system 100 are configured specifically for the respective vehicle 10 and tailored to it.

Optionally, the remote access server 40 can inform the intermediate server 30 about the specific configuration of the communication. The intermediate server 30 then establishes the first communication link and the second communication link as well as the tunnel according to this configuration and based on the vehicle identification feature.

In some embodiments, a processor unit in the remote access server 40 is configured specifically, and in particular specifically for the vehicle, for remote access to the vehicle 10, for example via software defined networking (SDN). This takes place in particular before the remote access to the vehicle 10 is carried out. The remote access server 40 dynamically adapts the configuration of the processor unit according to the vehicle identification feature, such as vehicle identification number (VIN), vehicle manufacturer and/or control device 11, 12. This means that the correct remote access functions can be selected and provided by the processor unit or the remote access server 40 on a vehicle-specific basis. Remote access can then take place on a vehicle-specific basis using the remote access server 40.

In particular, the activation message can be generated in relation to the vehicle identification feature and/or the control device identification feature. This means that the activation message can also be configured and created specifically for the vehicle 10. The activation message can be created, for example, by the processor unit configured for the vehicle 10. Using the VIN and, optionally, other vehicle data, the remote access server 40 can determine exactly which vehicle 10 is involved. The corresponding communication parameters for the vehicle-specific communication can then be compiled via the communication device 20 on the vehicle 10.

The encryption of the data or exchanged messages can take place in the intermediate server 30.

Optionally, it can be the case that the mode change is only carried out when an additional consent message is received from a user. For example, it may be necessary for a user or the vehicle driver to expressly consent to the remote access of their vehicle 10, in particular before the connection is established. In this case, the following steps can be carried out:

Now the communication device 20 is in the remote access mode and remote access can take place in the following step:
carrying out (S50-S53) the remote access to the at least one on-board control device 11, 12 by the remote access server 40.

Remote access is preferably carried out in real time. In other words, apart from transmission-related latency times, the on-board control devices 11, 12 are accessed in real time.

A request for remote access can be received before the first communication link is established. The request for remote access can optionally be generated in the communication device 20 or in a mobile device 60. The communication device 20 or, if present, the mobile device 60 sends the request to the intermediate server 30. From here, the request can be forwarded so that the remote access server 40 also learns of the request. The request can thus be received and forwarded at various points, for example in the communication device 20, in the intermediate server 30 and/or in the remote access server 40. The request can be generated by a call from the mobile device 60 to a call center.

The request typically contains at least one vehicle identification feature for identifying the vehicle 10 (see above) and/or an identification means for identifying the communication device 20. The method may comprise at least one of the following steps:
Establish the first communication link based on the request,
Establishing the second communication link based on the request and
Establishing the bidirectional communication channel between the communication device 20 and the remote access server 40 based on the request.

Typically, the activation message is sent via the established communication channel between the communication device 20 and the remote access server 40, after which the remote access mode is activated. The following step is then carried out:
carrying out remote access by the remote access server 40 via the bidirectional communication channel.

To increase system security, the method can optionally include the following step:
receiving a consent message, in particular a text or voice message, to agree to remote access.

The consent message may be received by the communication device 20, the intermediate server 30 and/or the remote access server 40. The consent message can, for example, be entered locally at the communication device 20, e.g. via a corresponding input device of the communication device 20 or in the vehicle 10. However, the consent message can also be received by a mobile device 60 (see FIGS. 4 and 6) or entered there by a user. The mobile device 60 may be communicatively connected to the communication device 20, e.g. wirelessly such as via Bluetooth or WiFi and/or wired. Optionally, the mobile device is connected to the intermediate server 40 via an air interface.

If the consent message is received by the communication device 20, the following step may be performed:
switching from the data transmission mode to the remote access mode based on the activation message and the consent message.

The consent message can be used to ensure that remote access via the remote access server 40 is only enabled if the remote access is confirmed and enabled by a user. The consent message can be sent or received before or after the activation message is sent.

Alternatively or additionally, it is also possible that the construction of the tunnel depends on the presence of the consent message. In this case, the next step can be carried out:
establishing the bidirectional communication channel between the communication device 20 and the remote access server 40 based on the request and the consent message.

Usually, identification of the vehicle 10 is required so that the remote access server 40 can assign the fault codes to a specific manufacturer and vehicle type.

In one variant, the remote access server 40 sends a request to identify the vehicle 10 to the intermediate server 30, which forwards the request to the communication device. The communication device 20 then sends at least one vehicle identification feature of the vehicle 10, which may be stored in a memory on the vehicle, to the remote access server 40 via the intermediate server 30.

The remote access server 40 can then request error codes from the vehicle 10, for example. For example, the intermediate server 30 forwards the request from the remote access server 40 to the communication device 20, which in turn addresses the corresponding vehicle control device 11, 12. The vehicle 10 then sends (S14) the requested error codes to the communication device 20, which sends the error codes to the remote access server 40 using the intermediate server 30. Once received, the error codes can be analyzed or evaluated by the remote access server 40.

The aim of vehicle diagnostics is to be able to determine how serious a malfunction is, which component in the vehicle 10 may be defective and how this component can be repaired. In order to determine which component of the vehicle is defective, the remote access server 40 evaluates the fault codes which, as described above, are generated by the at least one vehicle control device 11, 12 during operation of the vehicle 10 by evaluating the sensor readings and are stored in a memory on the vehicle.

Following a corresponding request, the vehicle control devices 11, 12 are designed to read out the fault codes stored in the vehicle 10 and transmit them to the communication device 20. The communication device 20 can therefore communicate directly with the respective vehicle control device 11, 12 in order to request and obtain the required fault codes from the vehicle control device 11, 12. By analyzing the fault codes, it is possible to diagnose whether and which vehicle components need to be repaired or replaced in order to rectify the problem. Therefore, by evaluating the fault codes (vehicle diagnosis), a conclusion can be drawn as to which vehicle components are defective and need repairing.

For a more precise diagnosis, the remote access server 40 can also request sensor readings from the vehicle 10 (or the corresponding control devices 11, 12). This is done, for example, via a request that is forwarded to the vehicle 10 via the intermediate server 30 and the communication device. The vehicle 10 (or the on-board control devices 11, 12) retrieves the requested sensor readings from the vehicle's memory or addresses corresponding vehicle sensors to output or record the sensor readings. The sensor readings are then sent from the vehicle 10 to the communication device 20 and further sent via the intermediate server 30 to the remote access server 40 for further evaluation or processing. Based on the fault codes, the vehicle identification feature and the sensor readings, the remote access server 40 can determine which component in the vehicle 10 is defective and requires repair.

Furthermore, the remote access server 40 can send commands to the vehicle 10 via the communication device 20. For example, a command to the vehicle 10 comprises a setting of the sensor or a change in the setting of the sensor (e.g. basic setting), wherein the setting includes, for example, a sensitivity of the sensor, a frequency of the measurements and/or a time sequence of the measurements.

Additionally or alternatively, the status of the vehicle 10 can be changed or set by the remote access server 40 via a corresponding message. In this context, the servicing interval, control of actuators, or the like would be conceivable, for example.

The vehicle 10 can also receive new software components or updates, which the remote access server 40 sends to the vehicle 10 via the units 20, 30.

As already indicated above, a mobile device 60 such as a mobile telephone, smartphone, smartwatch, laptop, computer, tablet PC or the like can also be provided in the system 100, which is connected on the one hand to the vehicle 10, in particular via the communication device 20, and on the other hand to the intermediate server 30. The mobile device 60 is shown in FIGS. 4 and 6. For example, the request and/or the consent message can be sent via the mobile device 60. In addition, the entire remote access process can be initiated via the mobile device 60. The mobile device 60 can be uniquely identified by an identification feature, e.g. IMEI (international mobile equipment identity).

The remote access mode should preferably only be activated when the vehicle is not moving. If changes are made to the control devices 11, 12 while the vehicle 10 is in motion, this can endanger the safety of the vehicle and its occupants. On the other hand, the transmission mode can also be activated when the vehicle is moving or driving.

It may therefore be useful to implement the following additional steps:
judging whether the vehicle 10 is moving, in particular using GPS data, satellite data, radio positioning signals or movement data from movement sensors.

To assess whether the vehicle 10 is moving, engine speed sensors, speedometers, motion sensors and other vehicle sensors in the vehicle 10 can be used, for example. The assessment as to whether the vehicle 10 is moving can thus be made in the vehicle 10 itself or outside the vehicle 10, for example by the intermediate server 30 or the remote access server 40. In the latter case, GPS data, satellite data and radio positioning signals can be used as an alternative or in addition for the assessment. Depending on where the assessment is made, a message can be sent to the other components of the system 100 to inform them of this.

Further steps include the following actions:
if it is determined that the vehicle 10 is moving: terminating the remote access mode and/or activating the data transmission mode and/or canceling the communication channel between the communication device 20 and the remote access server 40,
if it is determined that the vehicle 10 is at a standstill: activating the remote access mode and/or establishing the communication channel between the communication device 20 and the remote access server 40 and/or maintaining the communication channel between the communication device 20 and the remote access server 40.

The remote access mode can therefore be activated, maintained or terminated depending on the determination of whether the vehicle 10 is moving or not.

According to an additional or alternative safety measure, the driving operation of the vehicle 10 can be disabled as long as the communication device 20 is in remote access mode and/or the remote access server 40 performs remote access to the control devices 11, 12. Driving operation can only be enabled again once remote access has been completed and the communication device 20 is back in the data transmission mode.

It may be provided that a transport protocol is provided between the at least one control device 11, 12 of the vehicle 10 and the communication device 20, which prescribes time conditions to ensure transmission that are significantly shorter than would be feasible via the air interface 25. Preferably, the communication device 20 therefore includes means for maintaining the time conditions in the in-vehicle communication by sending time-correct signals.

The following step can be carried out additionally or alternatively:
periodically sending keep-alive signals to the communication device 20 to maintain the remote access mode.

It may be that the keep-alive signals are sent depending on a determined latency time. The latency time can be determined, for example, via time measurements of the communication paths. Vehicle communication parameters such as 7F handling can also be used to compensate for latency times.

Optionally, the communication between the remote access server 40 and the intermediate server 30 can take place via an interposed second communication device 70, which is shown schematically in FIGS. 5 and 6. The second communication device 70 may perform similar functions to the first communication device 20 and may have similar components to the first communication device 20. Thus, the second communication device 70 can be designed as a gateway device, which can be assigned to receiving and transmitting data and, for example, for ensuring security functions. The second communication device 70 may include hardware such as a control and processing unit, a memory and communication means. Typically, the communication device 70 is connected to the remote access server 40 by means of signal lines 75 (i.e. wired). Alternatively, this connection can also be wireless, for example via a wireless local connection such as Bluetooth or WiFi. Sometimes the communication device 70 is also an integral part of the remote access server 40 and as such is integrated into it. The communication device 70 may also be implemented at least partially as a software solution in the remote access server 40. The communication device 70 can thus be arranged in, on or at the remote access server 40. In particular, the communication device 70 is designed to process outgoing data streams from the remote access server 40 and to process data streams from external units 10, 20, 30, 60, 70 going to the remote access server 40. In this respect, the communication device 70 can have a first transmitter and receiver unit and a second transmitter and receiver unit, which are provided for inbound and outbound communication respectively. Sometimes the communication device 70 can be designed as a dongle.

It may be provided that the communication between the remote access server 40 and external units such as the intermediate server 30 and/or the communication device 20 in the remote access mode takes place via the second communication device 70, preferably exclusively. In particular, the aforementioned tunnel can be established in remote access mode between the two communication devices 20, 70. In the data transmission mode, communication can also take place via other channels, as indicated in FIGS. 5 and 6 by the double arrow between the intermediate server 30 and the remote access server 40.

The functionality and logic of the second communication device 70 can also be completely taken over by the remote access server 40. This case is shown in FIGS. 3 and 4.

It should be noted that the first communication device 20, the intermediate server 30, the remote access server 40, the mobile device 60 and/or the second communication device may each be connected to the Internet.

Remote communication can also be enabled for vehicles 10 in which security access is implemented by the vehicle manufacturer for secure diagnostic access to the vehicle 10. In this case, an authentication process specified by the manufacturer can be carried out. For this purpose, requests for personal information for authentication may be obtained from an external body, such as a call center, as well as approval from the vehicle driver or user. This process may be added to the remote access mode or the data transmission mode. The decisive factor here is which specifications the respective vehicle manufacturer requires for diagnostic communication between the control devices 11, 12 and external components.

It is understood that the features or steps shown in FIGS. 1-6 and described above can be combined with each other, provided that the combinations are not mutually exclusive.

### LIST OF REFERENCE SIGNS

10 vehicle
11 vehicle control device
12 vehicle control device
13 OBD interface
15 signal lines
20 first communication device
25 air interface
30 intermediate server
40 remote access server
60 mobile device
70 second communication device
75 signal lines
100 system

1. A method for remote access to a vehicle via a remote access server, wherein the remote access server is designed to access at least one on-board control device in order to carry out the remote access, wherein a communication device arranged in, on or near the vehicle is designed to communicate with an intermediate server via an air interface and to communicate with the at least one on-board control device on the vehicle via a further communication interface, the communication device including:
a data transmission mode which enables data transmission from the at least one on-board control device to the intermediate server; and
a remote access mode which enables remote access by the remote access server to the at least one on-board control device via the intermediate server;
the method comprising:
sending an activation message from the remote access server via the intermediate server to the communication device to activate the remote access mode and switch from the data transmission mode to the remote access mode; and
remotely accessing the at least one on-board control device by the remote access server.

2. A method for remote access to a vehicle, having a communication device which is arranged in, on or by the vehicle and is designed to communicate with an intermediate server via an air interface and to communicate with at least one on-board control device via a further communication interface, the communication device including:
a data transmission mode which enables data transmission from the at least one on-board control device to the intermediate server; and
a remote access mode which enables access by a remote access server to the at least one on-board control device via the intermediate server;
the method comprising:
receiving an activation message from the remote access server via the intermediate server; and
switching from the data transmission mode to the remote access mode based on the activation message.

3. A method for remote access to a vehicle, wherein a communication device arranged in, on or by the vehicle is designed to communicate with an intermediate server via an air interface and to communicate with at least one on-board control device via a further communication interface, the communication device including:
a data transmission mode which enables data transmission from the at least one on-board control device to the intermediate server; and
a remote access mode which enables remote access by a remote access server to the at least one on-board control device via the intermediate server;
the method comprising:
receiving, by the intermediate server, an activation message from a remote access server; and
forwarding the activation message to the communication device via the air interface to switch from the data transmission mode to a remote access mode, wherein the remote access mode enables access by the remote access server to the at least one on-board control device via the intermediate server, based on the activation message.

4. The method according to claim 3, further comprising:
receiving a consent message, including at least one of a text message or a voice message to consent to remote access;
switching from the data transmission mode to the remote access mode based on the activation message and the consent message.

5. The method according to claim 1, further comprising:
establishing a first communication link between the communication device and the intermediate server via the air interface;
establishing a second communication link between the intermediate server and the remote access server; and
establishing a bidirectional communication channel between the communication device and the remote access server via the intermediate server.

6. The method according to claim 5, further comprising:
receiving a request for remote access from a mobile device, the request containing at least one identifier for identifying at least one of the vehicle or the communication device;
establishing the bidirectional communication channel between the communication device and the remote access server based on the request; and
carrying out remote access by the remote access server via the bidirectional communication channel.

7. The method according to claim 6, further comprising:
determining whether the vehicle is moving, using at least one of GPS data, satellite data, a radio positioning signal, or movement data from one or more movement sensors;
responsive to a determination that the vehicle is moving at least one of: terminating the remote access mode, activating the data transmission mode, or interrupting the bidirectional communication channel between the communication device and the remote access server; and
responsive to a determination that the vehicle is at a standstill at least one of: activating the remote access mode, establishing the bidirectional communication channel, or maintaining the bidirectional communication channel.

8. The method according to claim 1, wherein the vehicle comprises a plurality of control devices, wherein the data transmission from the at least one on-board control device to the intermediate server in the data transmission mode is limited to a first group of predetermined on-board control devices, wherein the remote access in the remote access mode extends to a second group of on-board control devices, and wherein the first group is different from the second group.

9. The method according to claim 1, wherein the remote access server is authorized in the remote access mode to read, write and change at least one of data, settings, or programs in the at least one on-board control device, and wherein while in the data transmission mode the data, settings, or programs of the at least one on-board control device can only be read.

10. The method according to claim 1, wherein at least one of the remote access or the activation message are configured based on at least one of a vehicle identification feature or a control device identification feature.

11. The method according to claim 1, wherein the remote access comprises at least one of remote operation, remote control, remote diagnosis, remote support, remote configuration, remote maintenance, software updating, or remote flashing of the at least one on-board control device by the remote access server.

12. (canceled)

13. (canceled)

14. The method of claim 2, wherein the communication device according to includes a virtual switch configured to switch between the data transmission mode and the remote access mode.

15. The method of claim 14, wherein the further communication interface of the communication device is connectable to an on-board diagnostic interface via at least one of a wireless interface, a mechanical interface, or an electrical interface.

16. (canceled)

17. (canceled)

18. (canceled)

19. A system for remote access to a vehicle, the system comprising:
a remote access server to access an on-board control device to carry out remote access of the vehicle;
an intermediate server; and
a communication device located in, on, or near the vehicle to communicate with the intermediate server via an air interface and communicate with the on-board control device via a second communication interface, wherein the communication device includes:
a data transmission mode to enable data transmission from the on-board control device to the intermediate server; and
a remote access mode to enable remote access by the remote access server to the on-board control device by via the intermediate server.

20. The system of claim 19, further comprising:
processing circuitry configured to:
cause an activation message to be sent from the remote access server via the intermediate server to the communication device to activate the remote access mode; and
cause the remote access server to remotely access the on-board control device.

21. The system of claim 20, wherein activating the remote access mode includes switching from the data transmission mode to the remote access mode.

22. The system of claim 20, wherein the processing circuitry is further configured to:
establish a first communication link between the communication device and the intermediate server via the air interface;
establish a second communication link between the intermediate server and the remote access server; and
establish a bidirectional communication channel between the communication device and the remote access server via the intermediate server.

23. The system of claim 22, wherein the processing circuitry is further configured to:
receive a request for remote access from a mobile device, wherein the request includes at least one identifier for identifying at least one of the vehicle or the communication device;
establish the bidirectional communication channel between the communication device and the remote access server in response to the request; and
causing the remote access server to remotely access the communication device via the bidirectional communication channel.

24. The system of claim 22, wherein the processing circuitry is further configured to:
determine whether the vehicle is moving;
responsive to a determination that the vehicle is moving, at lest one of: terminating the remote access mode, activating the data transmission mode, or interrupting the bidirectional communication channel between the communication device and the remote access server; and
responsive to a determination that the vehicle is not movie, at least one of: activating the remote access mode, establishing the bidirectional communication channel, or maintaining the bidirectional communication channel.

25. The system of claim 24, wherein the determination whether the vehicle is moving is made using at least one of: GPS data, satellite data, a radio positioning signal, or movement data from one or more movement sensors located on, or coupled to the vehicle.
